(19) United States
(12) Patent Application Publication
(10) Pub. No.: US 2025/0202019 A1
(43) Pub. Date: Jun. 19, 2025

(54) ELECTRIC VEHICLE POWERTRAIN CONTACTOR NOISE ATTENUATION MOUNTING CONFIGURATION

(71) Applicant: FCA US LLC, Auburn Hills, MI (US)

(72) Inventors: William Mu, Troy, MI (US); Qingyuan Tan, LaSalle (CA)

(21) Appl. No.: 18/538,392

(22) Filed: Dec. 13, 2023

(51) Int. Cl. H01M 50/262; B60L 3/00; H01M 50/242; H01M 50/249; H01M 50/574

(52) U.S. Cl. CPC H01M 50/262; B60L 3/0046; H01M 50/242; H01M 50/249; H01M 50/574; H01M 2200/00; H01M 2220/20

(57) ABSTRACT

A mounting configuration for a battery disconnect unit (BDU) system for an electrified vehicle includes a BDU housing, a battery housing structure and a first mounting configuration. The BDU housing houses at least one of a contactor and a resettable circuit protection device of the BDU. The first mounting configuration includes a first fastener, a first sleeve, and a first pad. The first sleeve includes a first sleeve bore. The first pad has a body including a collar portion and a skirt portion, the body defining a first pad bore. The first pad is formed of sound absorbing material. The first fastener locates through the first sleeve bore, the first pad bore and couples to the housing. The first mounting configuration mitigates vibration transfer between the contactor or resettable circuit protection device and the BDU housing.

### FIELD

The present application generally relates to electrified vehicle high voltage architectures and, more particularly, to a noise attenuating mounting configuration for contactors and circuit protection devices used in electrified vehicle high voltage architectures.

### BACKGROUND

Today's electrified vehicles have high voltage architectures for powering one or more electric motors and for charging a high voltage onboard battery. These high voltage architectures include a high voltage battery system that is selectively connected to different electric loads or charging the circuit by closing one or more contactors. Thermal fuses are often implemented for current spike protection at the high voltage bus. When a thermal fuse is blown, however, it requires replacement, which could be a timely and costly service procedure. In addition, there is a possibility that the contactors could weld closed during high current spikes, regardless of the state of the thermal fuse(s). Contactor welding could further increase service time/costs. Some alternative contactor configurations include movable contacts that can be actuated in a switching configuration. In such examples, undesirable noise can sometimes be created resulting from the moving contact engaging the static contact. Accordingly, while such conventional electrified vehicle high voltage architectures do work well for their intended purpose, there exists an opportunity for improvement in the relevant art.

### SUMMARY

According to one example aspect of the invention, a mounting configuration for a battery disconnect unit (BDU) system for an electrified vehicle includes a BDU housing, a battery housing structure and a first mounting configuration. The BDU housing houses at least one of a contactor and a resettable circuit protection device of the BDU. The first mounting configuration includes a first fastener, a first sleeve, and a first pad. The first sleeve includes a first sleeve bore. The first pad has a body including a collar portion and a skirt portion, the body defining a first pad bore. The first pad is formed of sound absorbing material. The first fastener locates through the first sleeve bore, the first pad bore and couples to the housing. The first mounting configuration mitigates vibration transfer between the contactor or resettable circuit protection device and the BDU housing.

In some implementations, the skirt portion of the first pad locates between and engages the contactor and the BDU housing.

In some implementations, the mounting configuration further includes a second fastener, a second sleeve and a second pad. The second sleeve has a second sleeve bore. The second pad has a body including a collar portion and a skirt portion, the body defining a second pad bore, the first pad formed of sound absorbing material. The second fastener locates through the second sleeve bore, the second pad bore and couples to the battery housing structure. The second mounting configuration mitigates vibration transfer between the BDU housing and the battery housing structure.

In some implementations, the skirt portion of the second pad locates between and engages the BDU housing and the battery housing structure

In some implementations, the first fastener threadably mates with the BDU housing.

In some implementations, the second fastener threadably mates with the battery housing structure.

In some implementations, the first sleeve is formed of metallic material such as copper.

In some implementations, the second sleeve is formed of metallic material such as copper.

According to another example aspect of the invention, a mounting configuration for a battery disconnect unit (BDU) system for an electrified vehicle includes a BDU housing, a battery housing structure, a first mounting configuration, and a second mounting configuration. The BDU housing houses at least one of a contactor and a resettable circuit protection device of the BDU. The first mounting configuration includes a first fastener, a first sleeve, and a first pad. The first sleeve includes a first sleeve bore. The first pad has a body including a collar portion and a skirt portion, the body defining a first pad bore. The first pad is formed of sound absorbing material. The first fastener locates through the first sleeve bore, the first pad bore and couples to the housing. The first pad engages both the contactor and the BDU housing to offset the contactor and the BDU housing thereby mitigating vibration transfer between the contactor and the BDU housing. The second mounting configuration includes a second fastener, a second sleeve, and a second pad. The second sleeve includes a second sleeve bore. The second pad has a body including a collar portion and a skirt portion, the body defining a second pad bore. The second pad is formed of sound absorbing material. The second fastener locates through the second sleeve bore, the second pad bore and couples to the battery housing structure. The second mounting configuration mitigates vibration transfer between the BDU housing and the battery housing structure.

In some implementations, the skirt portion of the first pad locates between and engages the contactor and the BDU housing.

In some implementations, the skirt portion of the second pad locates between and engages the BDU housing and the battery housing structure

In some implementations, the first fastener threadably mates with the BDU housing.

In some implementations, the second fastener threadably mates with the battery housing structure.

In some implementations, the first sleeve is formed of metallic material such as copper.

In some implementations, the second sleeve is formed of metallic material such as copper.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example battery disconnect unit (BDU) system according to the principles of the present application;

FIG. 2 is a perspective view of an example configuration of the BDU system including a mounting configuration that mounts the BDU to a bracket of the vehicle according to the principles of the present application; and

FIG. 3 is a sectional view taken along lines 3-3 of the BDU of FIG. 2 showing a first mounting configuration that mounts a contactor relative to a housing or box of the BDU and a second mounting configuration that mounts the BDU relative to the bracket of the vehicle, the first and second mounting configurations mitigating noise and vibration according to the principles of the present application.

### DESCRIPTION

As previously discussed, conventional electrified vehicle high voltage architectures include separate contactors and thermal fuses. Replacing blown thermal fuses and/or welded contactors requires substantial service time/costs. Thus, there exists an opportunity for improvement in the relevant art. One particularly desirable high voltage architecture is to replace the contactors and the thermal fuse with a resettable circuit protection device in the battery disconnect unit (BDU) circuit. One exemplary resettable circuit protection device includes a Breaktor® provided by Eaton Corporation. This simplifies the overall circuit design and also avoids the need to replace a blown thermal fuse as the resettable circuit protection device is resettable. Accordingly, improved switchable BDU systems and methods that utilize protection devices having contactors and resettable circuit protection devices are presented herein. In some implementations, these protection devices could also integrate temperature sensors. Multiple protection devices could be implemented in an existing BDU architecture in place of existing contactors and thermal fuses to achieve the same functionality without the drawbacks of time consuming and expensive service as described above. In addition to reduced service time/costs, the BDU has less part counts and a more reliable and robust customer experience and engineering design.

During operation of the contactor, control current is applied to the contactor energizing an electromagnet which creates a magnetic field that causes the core of the contactor to move an armature. The two contacts are generally held together by the electromagnetic force, allowing current to pass through the contacts to the load. Since contactors are designed with rapidly opening and closing contacts, the moving contacts may bounce as they rapidly collide with fixed contacts when actuated causing undesirable noise in the BDU during switching.

The present disclosure provides a mounting configuration for the BDU that attenuates this undesirable noise. The mounting configuration includes a series of fasteners that secure (i) the contactor and/or resettable circuit protection device to the BDU and (ii) the BDU relative to the vehicle architecture. The mounting configuration provides a sleeve and pad arrangement that minimizes vibration transfer from the contactor to the BDU and from the BDU to the vehicle architecture and therefore reduces noise observed by the vehicle occupants (and confirmed by measured vibration instruments). The mounting configuration provides a low cost solution that avoids redesigning the components of the BDU or introducing an active control strategy to compensate for mechanical noise emanating from the contactor switching.

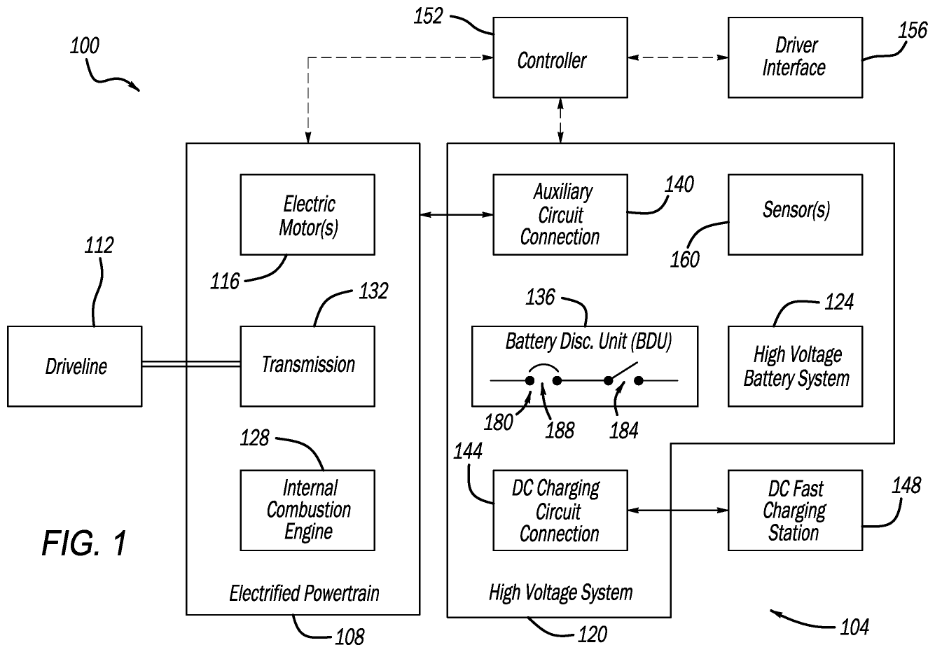

Referring now to FIG. 1, a functional block diagram of an electrified vehicle 100 having an example switchable BDU system 104 according to the principles of the present application is illustrated. The electrified vehicle 100 (also referred to as “vehicle 100”) generally comprises an electrified powertrain 108 configured to generate and transfer drive torque to a driveline 112 for vehicle propulsion. The electrified powertrain 108 includes one or more electric motors 116 that are powered by high voltage power provided by a high voltage system 120 that includes a high voltage battery system 124. In some implementations, the electrified powertrain 108 has a hybrid configuration and also includes an optional internal combustion engine 128 configured to combust a mixture of air and liquid fuel (gasoline, diesel, etc.) to generate mechanical energy (drive torque), which could be converted into electrical energy (e.g., for battery recharging and/or powering auxiliary loads). The engine 128 can also be used as a generator to recharge the high voltage battery system 124 and/or be connected directly to the transmission 132 (e.g., a multi-speed automatic transmission) to pass on the generated torque to the driveline 112.

The high voltage system 120 further comprises a BDU 136 that is configured to connect the high voltage battery system 124 to auxiliary loads (e.g., the electrified powertrain 108) via an auxiliary circuit connection 140 or to a charging system (e.g., a DC fast charging station 148) via a DC charging circuit connection 144. A controller 152 is configured to control operation of the electrified vehicle 100. This includes, for example, controlling the electrified powertrain 108 to generate and transfer an amount of drive torque to satisfy a torque request, which could be provided by a driver of the electrified vehicle 100 via a driver interface 156 (e.g., an accelerator pedal). The controller 152 could also control the BDU 136 as part of the control techniques of the present application. This could include, for example, receiving measurements from one or more sensors 160 (current sensors, voltage sensors, temperature sensors, etc.) associated with the high voltage system 120. It will also be appreciated that the BDU 136 could include its own controller, such as a battery management system (BMS).

The BDU 136 can be switchable in that it is configured to enable both 400V DC fast charging as well as boosted 800V DC fast charging. The BDU 136 can include one or more protection devices 180 according to some implementations of the present application, which provide for both power connection/transfer (via a contactor 184 or switch/relay) and circuit protection (via a resettable circuit protection device 188, e.g., in series with the contactor). It will be appreciated that the illustrated example configuration of the BDU 136 is merely exemplary and that the BDU 136 could have other suitable configurations. It will also be appreciated, however, that at least some of the above-described sensor functionality (i.e., sensor(s) 160) could be integrated into these protection devices (e.g., current spike sensing to open the circuit breaker, as well as optional temperature sensing). Depending on the specific configuration of the electrified vehicle 100 and, more particularly, the high voltage system 120, the switchable BDU 136 according to the present application could include any suitable number of these protection devices (i.e., one or more protection devices), or no protection devices.

As will become appreciated herein, the BDU 136 can have any configuration that includes a contactor 184 or a resettable circuit protection device 188 whereby it is desirable to dampen or minimize any noise caused from the contactor 184 switching or resettable circuit protection device switching. The mounting configuration described herein provides many advantages in that it is simple, low-cost and avoids modification of the BDU 136 and/or the contactor 184 and/or the resettable circuit protection device in the BDU. Moreover, the mounting configuration does not require special noise proof enclosures adapted for use with the BDU 136. Redesign of the BDU 136 housing to encompass any noise proof enclosure would incur extra cost as well as present durability, reliability and other performance challenges.

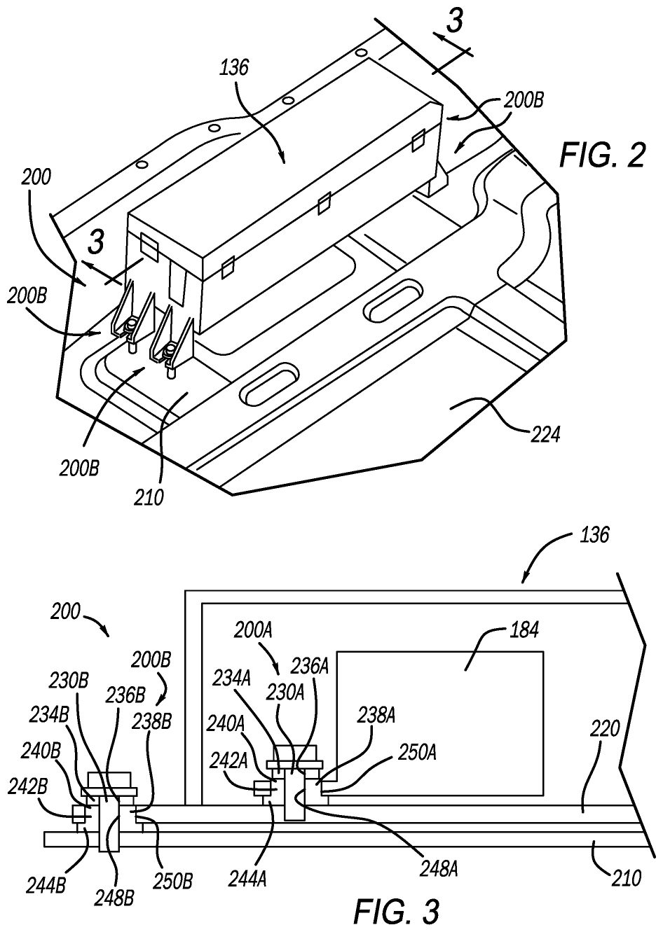

With additional reference now to FIGS. 2 and 3, a mounting configuration 200 for mounting the contactor 184 and/or the resettable circuit protection device 188 relative to the BDU 136 and mounting the BDU 136 relative to a battery housing structure such as a bracket 210 will be described in further detail. The exemplary mounting configuration 200 generally includes a first mounting configuration 200A (FIG. 3) that mounts the contactor 184 and/or the resettable circuit protection device 188 relative to a housing or box 220 of the BDU 136 and a second mounting configuration 200B that mounts the BDU 136 relative to the bracket 210. The battery housing structure 210 is described as a bracket and is merely exemplary. The battery housing structure can include a bracket or can be inclusive of a battery frame 224 that houses batteries (not shown) that power the vehicle 100.

In examples, each mounting configuration 200 (e.g., 200A and 200B) can be similarly configured. Referring specifically to FIG. 3, the first mounting configuration 200A includes a fastener 230A, a sleeve 234A and a pad 238A. In examples, the sleeve 234A can be formed of metallic material such as, but not limited to, copper. The sleeve 234A defines a bore 236A therethrough for receiving the fastener 230A.

The pad 238A can be formed of sound absorbing material. Example sound absorbing materials include elastomeric material such as, but not limited to, rubber. The elastomeric material absorbs vibration inputs and generally minimizes vibration transfer. The pad 238A includes a body portion 240A having a collar portion 242A and a skirt portion 244A. The contactor 184 and/or the resettable circuit protection device 188 defines a passage 250A that receives the pad 238A. The body portion 240A of the pad 238A defines a bore 248A that receives the fastener 230A therethrough. During assembly, the fastener 230A can be advanced through the bore 236A of the sleeve 234A, the bore 248A of the pad 238A and finally driven into the BDU box 220. In examples, the fastener 230A can threadably mate with the BDU box 220. The pad 238A generally locates in the passage 250A of the contactor 184 and/or the resettable circuit protection device 188. In particular, the skirt portion 244A can occupy a space between the contactor 184 and/or the resettable circuit protection device 188 and the BDU box 220. The pad 238A engages both the contactor 184 and/or the resettable circuit protection device 188 and the BDU box 220 to offset the contactor 184 and/or the resettable circuit protection device 188 relative to the BDU box 220 thereby mitigating vibration transfer between the contactor 184 and/or the resettable circuit protection device 188 and the BDU box 220.

The elastomeric pad 238A is configured to engage the contactor 184 and/or the resettable circuit protection device 188 and the BDU box 220 and therefore mitigate vibration transfer between the contactor 184 and/or the resettable circuit protection device 188 and the BDU box 220. It is appreciated that while FIG. 3 illustrates one mounting configuration 200A, additional fastener, sleeve and pad assemblies can be arranged between the contactor 184 and/or the resettable circuit protection device 188 and the BDU box 220.

With continued reference to FIG. 3, the second mounting configuration 200B includes a fastener 230B, a sleeve 234B and a pad 238B. In examples, the sleeve 234B can be formed of metallic material such as, but not limited to, copper. The sleeve 234B defines a bore 236B therethrough for receiving the fastener 230B.

The pad 238B can be formed of sound absorbing material such as elastomeric material described above. The elastomeric material absorbs vibration inputs and generally minimizes vibration transfer. The pad 238B includes a body portion 240B having a collar portion 242B and a skirt portion 244B. The housing 220 defines a passage 250B that receives the pad 238B. The body portion 240B of the pad 238B defines a bore 248B that receives the fastener 230B therethrough. During assembly, the fastener 230B can be advanced through the bore 236B of the sleeve 234B, the bore 248B of the pad 238B and finally driven into the bracket 210. In particular, the skirt portion 244B can occupy a space between the BDU box 220 and the bracket 210.

The elastomeric pad 238B is configured to engage the BDU box 220 and the bracket 210 and offset the BDU box 220 relative to the bracket 210. Vibration transfer is therefore mitigated between the BDU box 220 and the bracket 210. It is appreciated that while FIG. 3 illustrates one mounting configuration 200B, additional fastener, sleeve and pad assemblies can be arranged between the BDU box 220 and the bracket 210. For example, and as shown in FIG. 2, four mounting configurations 200B may be incorporated.

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A mounting configuration for a battery disconnect unit (BDU) system for an electrified vehicle, the mounting configuration comprising:
a BDU housing that houses at least one of a contactor and a resettable circuit protection device of the BDU;
a battery housing structure that houses a high voltage battery system of the electrified vehicle; and
a first mounting configuration including:
a first fastener;
a first sleeve having a first sleeve bore;
a first pad having a body including a collar portion and a skirt portion, the body defining a first pad bore, the first pad formed of sound absorbing material; and
wherein the first fastener locates through the first sleeve bore, the first pad bore and couples to the housing, the first mounting configuration mitigating vibration transfer between the at least one of the contactor and the resettable circuit protection device and the BDU housing.

2. The mounting configuration of claim 1, wherein the skirt portion of the first pad locates between and engages the at least one of the contactor and the resettable circuit protection device and the BDU housing.

3. The mounting configuration of claim 1, further comprising:
a second mounting configuration including:
a second fastener;
a second sleeve having a second sleeve bore;
a second pad having a body including a collar portion and a skirt portion, the body defining a second pad bore, the first pad formed of sound absorbing material; and
wherein the second fastener locates through the second sleeve bore, the second pad bore and couples to the battery housing structure, the second mounting configuration mitigating vibration transfer between the BTU housing and the battery housing structure.

4. The mounting configuration of claim 3, wherein the skirt portion of the second pad locates between and engages the BDU housing and the battery housing structure.

5. The mounting configuration of claim 1, wherein the first fastener threadably mates with the BDU housing.

6. The mounting configuration of claim 3, wherein the second fastener threadably mates with the battery housing structure.

7. The mounting configuration of claim 1, wherein the first sleeve is formed of metallic material.

8. The mounting configuration of claim 7, wherein the first sleeve is formed of copper.

9. The mounting configuration of claim 3, wherein the second sleeve is formed of metallic material.

10. The mounting configuration of claim 9, wherein the second sleeve is formed of copper.

11. A mounting configuration for a battery disconnect unit (BDU) system for an electrified vehicle, the mounting configuration comprising:
a BDU housing that houses at least one of the contactor and the resettable circuit protection device of the BDU;
a battery housing structure that houses a high voltage battery system of the electrified vehicle; and
a first mounting configuration including:
a first fastener;
a first sleeve having a first sleeve bore;
a first pad having a body including a collar portion and a skirt portion, the body defining a first pad bore, the first pad formed of sound absorbing material, wherein the first fastener locates through the first sleeve bore, the first pad bore and couples to the housing, the first pad engaging both the at least one of the contactor and the resettable circuit protection device and the BDU housing to offset the at least one of the contactor and the resettable circuit protection device and the BDU housing thereby mitigating vibration transfer between the at least one of the contactor and the resettable circuit protection device and the BDU housing; and
a second mounting configuration including:
a second fastener;
a second sleeve having a second sleeve bore;
a second pad having a body including a collar portion and a skirt portion, the body defining a second pad bore, the second pad formed of sound absorbing material wherein the second fastener locates through the second sleeve bore, the second pad bore and couples to the battery housing structure, the second mounting configuration mitigating vibration transfer between the BTU housing and the battery housing structure.

12. The mounting configuration of claim 11, wherein the skirt portion of the first pad locates between and engages the at least one of the contactor and the resettable circuit protection device and the BDU housing.

13. The mounting configuration of claim 11, wherein the skirt portion of the second pad locates between and engages the BDU housing and the battery housing structure.

14. The mounting configuration of claim 11, wherein the first fastener threadably mates with the BDU housing.

15. The mounting configuration of claim 11, wherein the second fastener threadably mates with the battery housing structure.

16. The mounting configuration of claim 11, wherein the first sleeve is formed of metallic material.

17. The mounting configuration of claim 16, wherein the first sleeve is formed of copper.

18. The mounting configuration of claim 11, wherein the second sleeve is formed of metallic material.

19. The mounting configuration of claim 18, wherein the second sleeve is formed of copper.
